(19) United States
(12) Patent Application Publication
(10) Pub. No.: US 2005/0142252 A1
(43) Pub. Date: Jun. 30, 2005

(54) Drinking straw with beverage additive

(76) Inventors: Matthew Peter deVito Brown, Berkeley, CA (US); Joel Aaron Shrock, Berkeley, CA (US); Adam Zev Tobin, Sausalito, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/912,407

(22) Filed: Aug. 4, 2004

Related U.S. Application Data
(60) Provisional application No. 60/492,604, filed on Aug. 5, 2003.

(51) Int. Cl. A23L 2/52

(52) U.S. Cl. 426/85

(57) ABSTRACT

A drinking straw with a beverage additive is described wherein the additive may include flavoring and/or coloring and/or vitamins and nutrients.

### PRIORITY CLAIM

This application claims priority under 35 USC 119(e) to U.S. Provisional Patent Application Serial No. 60/492,604, filed on Aug. 5, 2003 and entitled “Drinking Straw with Beverage Additive” which is incorporated herein by reference.

### FIELD OF THE INVENTION

The present invention is directed to a drinking straw which includes a beverage additive, such as flavoring and/or coloring and/or vitamins or nutrients.

### BACKGROUND OF THE INVENTION

It is desirable to provide a device for creating a flavored beverage so that, for example, a beverage, such as milk, may be converted into chocolate milk or ordinary water may be converted into a flavored beverage. One can simply place an additive into the beverage and mix the additive using a spoon. However, it is desirable to provide a device that permits the additive, the mixing mechanism and the drinking mechanism to be incorporated into a single device. It is further desirable to provide a device that permits the uniform mixing and dissolving of the additive into the beverage.

There are conventional devices that permit a flavoring to be incorporated into a drinking straw. For example, one conventional drinking straw has a flavoring object inside of the straw that is captured between a first and second screen so that liquid being sucked through the straw passes the flavoring object and is flavored. This drinking straw is a fairly complex and expensive to manufacture and does not guarantee a uniform distribution of the flavoring into the beverage. Another conventional drinking straw has powdered flavoring that is laminated to an interior surface of the drinking straw so that the flavoring dissolves as the liquid passes through the straw. This powdered flavoring may be formed of a honeycomb structure in which the powdered flavoring is adhered to the walls of the honeycomb structure. As with the prior conventional straw, this straw is fairly complex and expensive to manufacture and does not guarantee a uniform distribution of the flavoring into the beverage. Another conventional apparatus for providing a flavored beverage utilizes solid granules of flavoring agent trapped between end caps so that liquid flowing past the granules are flavored.

### BRIEF DESCRIPTION OF THE DRAWINGS

FIGS. 1A and 1B are diagrams illustrating one embodiment of the drinking straw in accordance with the invention;

FIG. 2 is a diagram illustrating another embodiment of the drinking straw in accordance with the invention; and

FIG. 3 is a diagram illustrating a preferred embodiment of the drinking straw in accordance with the invention.

### DETAILED DESCRIPTION OF THE PREFERRED EMBODIMENT

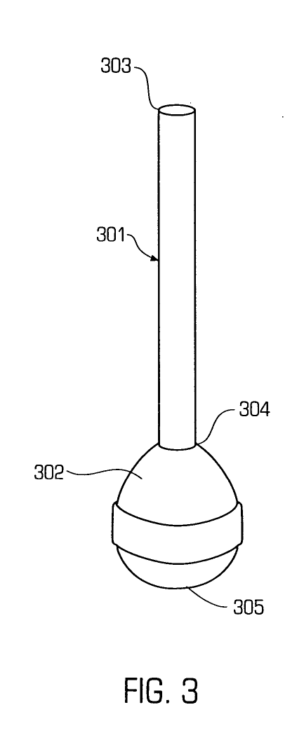

In the preferred embodiment of the present invention, an additive lozenge (302) in a solid form is attached to the lower end of a straw (301), as is shown in FIG. 3. The additive lozenge (302) is compacted directly onto the straw (301). To the casual observer, this would appear similar to a lollipop in shape. The critical difference is that the “handle” is a straw (301), and the “candy” is an additive lozenge (302) which quickly dissolves when stirred in a liquid as the lozenge is a pressed powered mixture. Once dissolved, the person mixing the additive lozenge into the liquid can drink the modified drink through a sip end (303) of the straw (301).

The additive lozenge (302) at the end of the straw can take any of a number of forms. For example, the additive lozenge (302) may be a tablet of a dextrose-based material, a pressed sugar material, a tablet of other edible materials, a powder contained in a sack that dissolves, or a powder in a device that lets liquid enter and leave in order to dissolve the powder, etc. The preferred embodiment is a tablet that includes flavoring and/or vitamins and/or sweetener, such as sugar or xylitol. The additive lozenge (302) may be manufactured in a wide variety of shapes, such as a star, the moon, or an animal.

The additive lozenge (302) will dissolve quickly due to one or more of the following: the type of additive materials selected, the additive materials are lightly packed and therefore porous, the additive materials are powdered, or the additive materials include, in a preferred embodiment, effervescence materials. The effervescence materials result in the lozenge breaking apart and dissolving more rapidly. The effervescence materials may include bicarbonates and citric acid or sugar encapsulated carbon dioxide. In a preferred embodiment, the effervescence materials may be bicarbonate and citric acid. Examples of existing fast-dissolve tableted consumables are Alka-Seltzer™ effervescing cold tablets, manufactured by Bayer of Leverkusen, Germany, and a common Japanese dextrose-based tableted candy designed to dissolve directly in your mouth, manufactured by Multizen Asia Limited Manufacturing of Kowloon, Hong Kong. In accordance with the invention, the lozenge may alter the flavor/taste and/or color of the beverage.

The straw (301) is preferably rigid enough that the user can successfully use the straw (301) to mix the additive into the liquid. The straw (301) may include one or more transverse extensions (not shown) at a lower end (304) which increase the surface area of the lower region (304) of the straw (301). This increased surface area would increase the agitation of the liquid when stirred, thereby increasing the speed of the dissolving or dispersion of the additive materials. In accordance with the invention, the straw may be made of any material, but preferably plastic, and it may be a single piece straw, a two piece telescoping straw (which may be used in situations with smaller packages such as a drink box) or an accordion straw which can be extended.

According to the preferred geometry of the present invention, the additive lozenge (302) is located at the lower end (304) of the straw, and preferably the lower end of the additive lozenge (302) is substantially coincident with a lower end (305) of the straw (301). Alternative embodiments include, but are not limited to, having the additive materials on the exterior surface of the straw (301), but with the open ends (304) and (305) of the straw (301) protruding through both sides of the additive lozenge; or having the additive materials inside the straw (301), either attached directly to the interior surface of the straw (301) or suspended inside the straw (301) via a suspension structure attached to the interior surface of the straw (301).

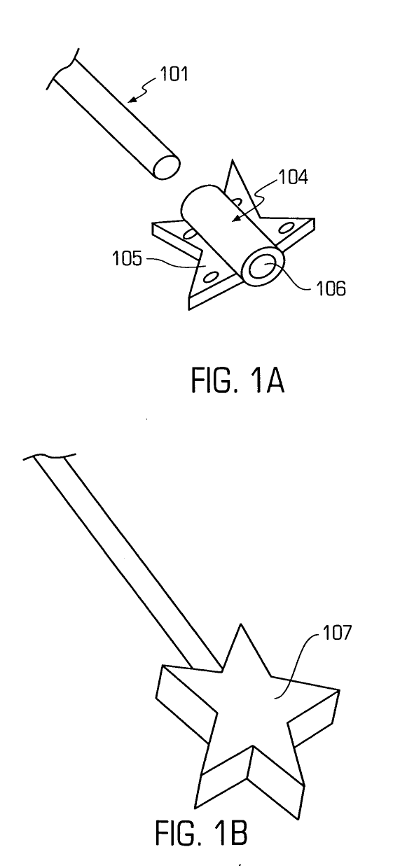

According to an alternate embodiment of the present invention shown in FIGS. 1A and 1B, a lozenge armature (104) is affixed at the lower end of the straw (101). The lozenge armature (104) has a through-bore (106), thereby extending the through-bore of the straw (101). The lozenge armature (104) provides a substrate on which an additive lozenge (107) may be formed. The lozenge armature (104) may have wings (105), which can have any shape; they need not necessarily be planar, cylindrical or symmetric. The additive lozenge (107) may block the through-bore (106) of the lozenge armature (104) so that the straw (101), when inserted into the lozenge armature (104), will not function as such until the additive lozenge substantially dissolves. Alternatively, the additive lozenge (107) may not block the through bore (106) of the lozenge armature (104). In production, the additive material will likely be first molded onto the lozenge armature (104), and then the lozenge armature (104) will be affixed to the straw (101) as a secondary operation. This can be achieved either by means of friction fit of the exterior surface of the straw (101) with the lozenge armature through bore (106), by forming the lozenge on a straw that has one or more dimples or by use of mechanical fastening device such as a lynch pin through both straw (101) and lozenge armature (104). This two-step production process is particularly useful for flavoring materials that must be formed at either high temperatures or high pressure, both of which could deform a standard drinking straw. Potential shapes for the lozenge armature (104) include, but are not limited to, fin geometric shapes, animals, people, licensed characters, etc. These shapes may be hidden from sight within the additive lozenge (107), and then become visible—as a surprise—once the additive lozenge (107) has dissolved.

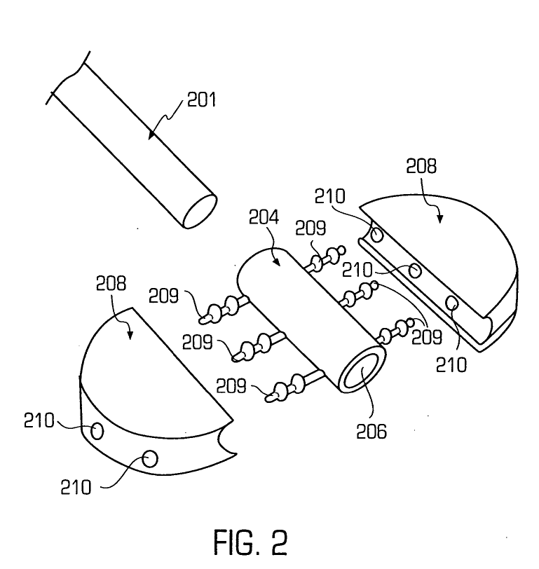

Another process for production of the present invention may involve molding an additive lozenge (208) separately from the lozenge armature and then affixing it mechanically to lozenge armature. As shown in FIG. 2, each of two additive lozenges (208) has the form of projected semi-circle (i.e., half a disk), with several through bored sockets (210). The additive lozenge (208) is attached to a lozenge armature (204) by means of a simple pin-and-socket friction mechanism where pins (209) on the lozenge armature (204) are friction fit into the sockets (210) molded in the additive lozenges (208). A lozenge armature through-bore (206) is then attached to a straw (201) using a friction fit as described above. This process will work with virtually any shape that can be separated into two distinct halves and reassembled to form the original shape.

The drinking straw with the additive in accordance with the invention (an exemplary embodiment of which is sold as the Drink Wand product made by Big Boing Ideas) can be used to create a wide variety of drinks: essentially, any drink that can be created by mixing a flavoring with a liquid, including, but not limited to, a fruit beverage, chocolate milk, Kool Aid™, ice tea, Gatoradem, Tang™, and Carnation Instant Breakfast™. In addition, the flavoring materials of a drinking straw with additive can be enhanced with vitamins, nutrients, medicines and other edible materials that are either soluble or easily dispersed as particles so as to form a suspension when stirred in liquid. Ingredients may also be included to enhance or accelerate solubility.

While the foregoing has been with reference to a particular embodiment of the invention, it will be appreciated by those skilled in the art that changes in this embodiment may be made without departing from the principles and spirit of the invention as set forth in the attached claims.

1. A flavored beverage generating device, comprising:
a straw having a sip end and a lower end;
a lozenge formed around the lower end of the straw having an additive material wherein the lozenge is adapted to be dipped into a beverage so that the lozenge dissolves into the beverage and forms a beverage with the additive material.

2. The device of claim 1, wherein the lozenge further comprises a substrate on which the lozenge is formed, the substrate further comprising a through hole into which the lower end of the straw is inserted to attach the straw to the lozenge.

3. The device of claim 2, wherein the substrate further comprises a pin that extends through the lower end of the straw and substrate to attach the substrate to the lower end of the straw.

4. The device of claim 1, wherein the lozenge is formed so that an end of the lozenge is substantially coextensive with the lower end of the straw.

5. The device of claim 2, wherein the lozenge further comprises a first part and a second part that are connected to the substrate.

6. The device of claim 5, wherein the first and second parts of the lozenge each further comprise one or more sockets bored through the first and second parts of the lozenge and wherein the substrate further comprises one or more pins that fit into the one or more sockets of the first and second parts of the lozenge to attach the first and second parts of the lozenge to the substrate.

7. The device of claim 1, wherein the lozenge further comprises one of a table made of a dextrose-based material, a pressed sugar material, a powder contained in a sack and a powder contained in a mechanism that permits the powder to dissolve into the beverage.

8. The device of claim 1; wherein the straw further comprises one or more transverse extensions at the lower end of the straw that increase the agitation of the beverage.

9. The device of claim 1, wherein the lozenge further comprises an effervescence material that encourages the dissolving of the lozenge in the beverage.

10. The device of claim 9, wherein the effervescence material further comprises a combination of bicarbonate and citric acid,

11. The device of claim 9, wherein the effervescence material further comprises sugar encapsulated carbon dioxide.

12. A method for creating a flavored beverage, comprising:
inserting a straw into a beverage, the straw having an additive lozenge formed around the outside of the straw; and
agitating the beverage using the straw with the additive lozenge in order to dissolve the additive lozenge into the beverage to form a modified beverage.
